(19) United States
(12) Patent Application Publication
(10) Pub. No.: US 2018/0082283 A1
(43) Pub. Date: Mar. 22, 2018

(54) SHARED CARD PAYMENT SYSTEM AND PROCESS

(71) Applicant: MASTERCARD INTERNATIONAL INCORPORATED, Purchase, NY (US)

(72) Inventor: Piyush Sharma, Pune (IN)

(21) Appl. No.: 15/710,443

(22) Filed: Sep. 20, 2017

(30) Foreign Application Priority Data
Sep. 20, 2016 (SG) 10201607852Y

(51) Int. Cl. G06Q 20/34; G06Q 20/40; G06Q 20/32; G06Q 20/38

(52) U.S. Cl. CPC G06Q 20/3572; G06Q 20/385; G06Q 20/3274; G06Q 20/4014

(57) ABSTRACT

A data processor implemented process for making a payment from a shared payment card is provided. The data processor implemented process includes a user device, including at least one computing device being configured to make a payment from a shared payment card, a data processor implemented process for authorizing a shared card payment, a data processor implemented process for conducting a payment transaction made with a shared card, a card association entity system, including at least one computing device being configured to authorize a shared card payment, a card association entity system including at least one computing device being configured to conduct a payment transaction made with a shared card, a data processor implemented process for performing a shared card payment transaction, and a payment system, including at least one computing device being configured to perform a shared card payment transaction.

### CROSS REFERENCE TO RELATED APPLICATIONS

This patent application claims priority to Singapore Application No. 10201607852Y filed on Sep. 20, 2016, the disclosure of which is incorporated by reference herein in its entirety as part of the present application.

### BACKGROUND

The present disclosure relates to a shared card payment system and process for authorizing and requesting payment transactions.

The use of electronic payment services has increased dramatically in recent decades. In particular, credit and debit card-based payment services have become integrated into everyday life due to their ability to allow a customer to complete purchases via the electronic transfer of funds from a payment account to a merchant's account. Card-based payments offer many advantages over cash payments, including that the customer can transfer funds to a merchant in any currency without needing to transport physical denominations or having to manually perform conversions from one currency type to another, while retaining the efficiency of a cash exchange. More recently, mobile payment services (e.g. Paypal, ApplePay, Android Pay, etc.) have been developed to allow customers to make payments without a physical credit or debit card, through the use of a portable mobile device, such as a smartphone. These services act as a “digital wallet” by storing the details of a customer's payment account and allowing the customer to make electronic payments from the account to a merchant without requiring the use of a physical card that is associated with the account.

Despite the convenience of these payment technologies, there remains room for improvement. It is desired to provide a system and process for shared card payments that alleviates one or more difficulties of the prior art, or to at least provide a useful alternative.

### BRIEF DESCRIPTION

A first aspect of the present disclosure provides a data processor implemented process for making a payment from a shared payment card, the process being executed by at least one processor, and including generating payment card data representing a payment card linked to a payment account of a first individual, said payment card linked to a card association entity and a corresponding issuing financial institution, processing the payment card data to generate authorization request data, the authorization request data requesting authorization for a second individual to make a payment using the payment account of the first individual, and transmitting the authorization request data to the card association entity and receiving in response payment authorization data, said payment authorization data representing an indication of whether the payment is authorized. If the payment is authorized, the transaction can be performed at a payment device when a payment account identifier and a corresponding security code, both of the payment authorization data, are presented to the payment device.

The payment card data may include an indication of one or more of, for example, the card number, the card association entity, identification information of the first individual, and so forth.

The payment card data may be generated based on the selection of the payment card from one or more shared payment cards.

Each of the one or more shared payment cards may be registered with their corresponding card association entity as a shared payment card in respect of the second individual.

The process of registering a candidate payment card as a shared payment card in respect of the second individual may include transmitting, to the card association entity, a request to register the candidate payment card, and receiving registration confirmation data from the card association entity that indicates, when the registration of the candidate payment card as a shared payment card is approved, that the candidate payment card is a registered shared payment card.

The request to register the candidate payment card may include, at least, for example, the card number, an indication of the issuing financial institution, the card ICA value of the candidate payment card and so forth.

The authorization request data may include, for example, the payment card data, transaction information data indicating details of the payment transaction to be performed by the second individual, identification data identifying the second individual, and the like.

The transaction information data can include, for example, a value of the payment, a currency of the payment, and so forth.

The data identifying the second individual may include one or more of, for example, the name, address, telephone number, email, username of the second individual, and the like.

The payment identifier can be a QR code, said QR code generated by the card association entity and containing the information of the payment account of the first individual.

The information of the payment account of the first individual can include one or more of, for example, the name of the first individual, a Personal Account Number (PAN) of the payment account, an expiration date of the payment card, a verification value of the payment card, and the like.

The security code is may be one of, for example, the PIN code of the payment card, a one time PIN (OTP) code, and so forth.

The OTP may be generated dynamically by the card association entity using an encryption algorithm with an associated OTP generation key to encrypt the PAN value in combination with a seed value.

The payment account identifier and the security code operate as a token pair encapsulating the PAN of the payment account and the PIN of the payment card during the exchanges of data between the card association entity and the second individual in relation to the payment.

The payment account identifier and security code may expire after a predetermined period of time, such that, once the payment account identifier and security code have expired, the payment transaction cannot be performed at the payment device, when the payment account identifier and the security code are presented to the payment device.

A second aspect of the present disclosure provides a user device, including at least one computing device being configured to make a payment from a shared payment card by generating payment card data representing a payment card linked to a payment account of a first individual, said payment card linked to a card association entity and a corresponding issuing financial institution, processing the payment card data to generate authorization request data, the authorization request data requesting authorization for a second individual to make a payment using the payment account of the first individual, and transmitting the authorization request data to the card association entity and receiving in response payment authorization data, said payment authorization data representing an indication of whether the payment is authorized. If the payment is authorized, the transaction can be performed at a payment device when a payment account identifier and a corresponding security code, both of the payment authorization data, are presented to the payment device.

The user device can be configured to make a payment from a shared payment card by implementing the earlier mentioned process.

A third aspect of the present disclosure provides a data processor implemented process for authorizing a shared card payment, the process being executed by the at least one processor, and including receiving authorization request data requesting authorization for a second individual to make a payment with a payment card linked to a payment account of a first individual, said payment card issued by an issuing financial institution, processing the received authorization request data to generate card owner notification data representing a notification of the second individual's request for authorization to make the payment, transmitting the card owner notification data to the first individual, said transmission performed over a communications network, receiving card owner authorization data representing the approval, by the first individual, of the payment request, processing the received card owner authorization data to generate payment authorization data, including an indication that the payment is authorized, and transmitting the payment authorization data to the second individual, such that the payment can be performed at a payment device when a payment account identifier and a corresponding security code, both of the payment authorization data, are presented to the payment device.

The payment card may be registered as a shared payment card in respect of the second individual.

The registration of a candidate payment card as a shared payment card in respect of the second individual may include receiving, from a user device, registration request data representing a request to register the candidate payment card, processing the registration request data to generate registration confirmation data that indicates, when the registration of the candidate payment card as a shared payment card is approved, that the candidate payment card is a registered shared payment card, and transmitting the generated registration confirmation data to the user device.

The registration request data may include, at least, an indication of the, for example, card number, the issuing financial institution, the card ICA value, of the candidate payment card and so forth.

The processing of the registration request data can include, for example, processing at least one of the card number, the indication of the issuing financial institution, and the card ICA value to generate a registration request notification indicating the intention of the second individual to register the candidate payment card as a shared payment card, transmitting the registration request notification to the issuing financial institution, receiving a registration request response from the issuing financial institution indicating the approval or rejection of the registration of the candidate payment card with the second individual, and generating, if the registration of the candidate payment card is approved, a registration key, said registration key uniquely representing the registration of the candidate payment card with the second individual.

The registration request response may be generated by the issuing financial institution based on whether the first individual approves or rejects the registration of the candidate payment card with the second individual.

The authorization request data may include, for example, the payment card data, transaction information data indicating details of the payment transaction to be performed by the second individual, identification data identifying the second individual, and so forth.

The transaction information data may include, for example, a value of the payment, a currency of the payment, and so forth.

The data identifying the second individual may include, for example, one or more of the name, address, telephone number, email, username of the second individual, and so forth.

The payment identifier may be a QR code, said QR code generated by the card association entity and containing the information of the payment account of the first individual.

The information of the payment account of the first individual includes one or more of, for example, the name of the first individual, a Personal Account Number (PAN) of the payment account, an expiration date of the payment card, a verification value of the payment card, and the like.

The security code may be one of, for example, the PIN code of the payment card, a one-time PIN (OTP) code, and the like.

The OTP can be generated dynamically using an encryption algorithm with an associated OTP generation key to encrypt the PAN value in combination with a seed value.

The payment account identifier and the security code may operate as a token pair encapsulating the PAN of the payment account and the PIN of the payment card during the exchanges of data between the card association entity and the second individual in relation to the payment.

The payment account identifier and security code may expire after a predetermined period of time, such that, once the payment account identifier and security code have expired, the payment transaction cannot be performed at the payment device, when the payment account identifier and the security code are presented to the payment device.

Another aspect of the present disclosure provides a data processor implemented process for conducting a payment transaction made with a shared card, the process being executed by at least one processor, and including receiving from a payment device i) transaction information data representing a payment transaction requested by an individual in respect of the payment account, and ii) payment authorization data, including an indication that the payment transaction is authorized, processing the payment authorization data and the transaction information data to produce validity data indicating whether the payment transaction specified by the transaction information data can be validly performed, the validity data based on an indication of prior authorization by the card owner for the individual to perform the payment transaction with the payment account, generating, if the payment transaction is valid, financial transaction data representing a standard financial transaction message for conducting the payment transaction, transmitting the standard financial transaction message to the issuing financial institution for processing, and receiving corresponding response data indicating the success or failure of the payment transaction, generating, if the response data indicates a success of the payment transaction, shared payment transaction record data indicating that the payment transaction has been performed with the payment card, and transmitting the response data to the payment device, to allow completion of the payment transaction.

The payment authorization data may include, for example, a payment account identifier, a corresponding security code and so forth.

The indication of prior authorization by the card owner may be provided by the payment authorization data generated in an earlier described manner.

Another aspect of the present disclosure provides a card association entity system, including at least one computing device being configured to authorize a shared card payment by carrying out the steps of: receiving authorization request data requesting authorization for a second individual to make a payment with a payment card linked to a payment account of a first individual, said payment card issued by an issuing financial institution, processing the received authorization request data to generate card owner notification data representing a notification of the second individual's request for authorization to make the payment, transmitting the card owner notification data to the first individual, said transmission performed over a communications network, receiving card owner authorization data representing the approval, by the first individual, of the payment request, processing the received card owner authorization data to generate payment authorization data, including an indication that the payment is authorized, and transmitting the payment authorization data to the second individual, such that the payment can be performed at a payment device when a payment account identifier and a corresponding security code, both of the payment authorization data, are presented to the payment device.

The card association entity system can configured to authorize a shared card payment by implementing the process as described earlier.

A card association entity system is also provided, including at least one computing device being configured to conduct a payment transaction made with a shared card by receiving from a payment device i) transaction information data representing a payment transaction requested by an individual in respect of the payment account, and ii) payment authorization data, including an indication that the payment transaction is authorized, processing the payment authorization data and the transaction information data to produce validity data indicating whether the payment transaction specified by the transaction information data can be validly performed, the validity data based on an indication of prior authorization by the card owner for the individual to perform the payment transaction with the payment account, generating, if the payment transaction is valid, financial transaction data representing a standard financial transaction message for conducting the payment transaction, transmitting the standard financial transaction message to the issuing financial institution for processing, and receiving corresponding response data indicating the success or failure of the payment transaction, generating, if the response data indicates a success of the payment transaction, shared payment transaction record data indicating that the payment transaction has been performed with the payment card, and transmitting the response data to the payment device, to allow completion of the payment transaction.

The card association entity system can be configured to conduct a payment transaction made with a shared card by implementing the process described earlier.

Another aspect of the present disclosure provides a data processor implemented process for performing a shared card payment transaction, the process being executed by at least one processor, and including receiving from a computing device of a second individual i) transaction information data representing a payment transaction requested in respect of the payment account, and ii) payment authorization data, including an indication that the payment transaction is authorized, processing the payment authorization data to generate authentication data indicating whether the second individual is permitted to transact the payment account, transmitting, if the second individual is permitted to transact the payment account, the payment authorization data and the transaction information data to a card association entity linked to the payment account, said card association entity configured to provide response data by processing the payment authorization data and the transaction information data described earlier, and processing the response data received from the card association entity to complete the transaction.

The payment authorization data may include a payment account identifier and a corresponding security code.

Generating the authentication data may include, for example, generating a candidate security code based, at least in part, on the payment account information within the payment identifier, comparing said candidate security code to the security code received within the payment authorization data and so forth.

The payment account identifier may include, for example, a PAN, and the security code is an OTP code, such that the candidate security code is a candidate OTP code generated based on said PAN.

The authentication data may be generated by transmitting the payment authorization data to the card association entity and receiving in response an indication of whether the second individual is permitted to transact the payment account.

Another aspect of the present disclosure provides a payment system, including at least one computing device being configured to perform a shared card payment transaction by receiving from a computing device of a second individual i) transaction information data representing a payment transaction requested in respect of the payment account, and ii) payment authorization data, including an indication that the payment transaction is authorized, processing the payment authorization data to generate authentication data indicating whether the second individual is permitted to transact the payment account, transmitting, if the second individual is permitted to transact the payment account, the payment authorization data and the transaction information data to a card association entity linked to the payment account, said card association entity configured to provide response data by processing the payment authorization data and the transaction information data as described earlier, and processing the response data received from the card association entity to complete the transaction.

The payment system can be configured to perform a shared card payment transaction by implementing the process as described earlier.

### BRIEF DESCRIPTION OF THE DRAWINGS

Some embodiments of the present disclosure are hereinafter described, by way of example only, with reference to the accompanying drawings, wherein:

FIG. 1 is a block diagram of a shared card payment system in accordance with some embodiments of the present disclosure;

FIG. 2 is a block diagram of a computing device within the shared card payment system;

FIG. 3 is a flow diagram of a process for performing a shared card payment transaction in accordance with some embodiments of the present disclosure;

FIG. 4 is a flow diagram of a process for user registration of the shared card payment transaction process;

FIG. 5 is a flow diagram of a process for adding a new shared payment card of the shared card payment transaction process;

FIG. 6 is a flow diagram of a process for performing authorization of a shared card payment transaction in accordance with some embodiments of the present disclosure;

FIG. 7 is a flow diagram of a process for generating payment authorization data of a shared card payment transaction authorization process;

FIG. 8 is a flow diagram of a process for conducting an authorized shared card payment transaction at a payment device in accordance with some embodiments of the present disclosure; and

FIG. 9 is a flow diagram of a process for conducting an authorized shared card payment transaction at a card association entity device in accordance with some embodiments of the present disclosure.

### DETAILED DESCRIPTION

### Overview

As a result of the wide spread adoption of card and mobile based electronic payment methods, it is often desirable for a person to share access to their payment account with one or more other individuals. Typically this is useful in situations where a degree of trust exists between the person and the other individuals. Conversely, a particular individual may desire to make a payment with the card or mobile based payment account of another person. Furthermore, such payments involving the use of another person's account by an individual are often ad-hoc or dynamic in nature, where the other person has no prior knowledge of the individual's desire to use their payment account. For example, a person may wish to use their spouse's credit card to make a cash withdrawal from the corresponding credit card payment account at an Automatic Teller Machine (ATM). Alternatively, a parent may want to allow a child, or other dependent, to use their payment account to complete a transaction via a retail point of sale (POS) device (such as, for example, to pay for the family's weekly groceries). In these situations, allowing one or more trusted individuals to access a card owner's corresponding payment account provides an efficient and convenient means for sharing funds, and to allow the trusted individual to make payments for goods and/or services on behalf of the card owner by using the payment account directly (as opposed to requiring a transfer of funds from the card owner to the individual's own payment account prior to the purchase or withdrawal).

Some specific shortcomings with existing card and mobile based payment technologies for allowing shared access to payment accounts have been identified. A characteristic of traditional card and mobile based payment services is that the use of a payment account is bound to the possession of the physical card, or a mobile device on which the digital wallet is operated. That is, in the example scenarios above the person requires their spouse's credit card to make the ATM withdrawal. Similarly, the person would need to provide their child or dependent with the payment card in order for a payment to be made at the POS terminal. The requirement of possessing a physical card to perform ATM or POS device transactions therefore limits the ability of a trusted individual to access the payment account of a person in situations where that person's card (or equivalently, the mobile device operating the person's digital wallet) cannot be obtained.

The described embodiments of the present disclosure include a shared card payment system and process for allowing controlled access, by one or more trusted individuals (such as a family member), to a payment account of a card owner. Specifically, the system and process described herein allows a card owner to register with the system and to nominate one or more of their credit or debit cards for which shared access is to be permitted (referred to herein as a “shared card”). Each shared card is associated with a particular card association entity (such as MasterCard), and a corresponding issuing financial institution (referred to in the art as the “issuer”). Other individuals that are registered with the system are able to withdraw from, or make payments using, one of the shared cards subject to the control of the card owner. An individual (referred to herein below as a “user”) uses the shared card payment system by first registering with the system, which involves submitting user identification details to the system. Following registration, the user is able to request the addition of one or more shared cards to the user's registered account, each corresponding to a payment account of a registered card owner. The request to add a shared card is verified by the card association entity and the card owner. Following a successful verification process, the shared card is added to the user's account allowing the user to perform electronic payments with the payment account associated with that card, subject to the authorization of each specific payment by the card owner.

Those skilled in the art will appreciate that embodiments of the system and process described herein are not limited to allowing a payment account of a person to be accessed by any particular individuals as such. The terms “family” and “family member” are used below in the general sense to represent an individual, or other person, who is regarded with a degree of trust by the person having ownership over the payment account that is shared (i.e. the card owner). The use of this term reflects one application of the system and process only, in which it is desirable for a card owner to allow only trusted individuals to access their corresponding card payment account, and should not be construed as a limiting feature. Accordingly, the embodiments described, and the exemplary situations presented, herein below are equally applicable to allow one or more arbitrary individuals managed access to a payment account, regardless of the relationship of each individual to the owner, and of the degree of familiarity or trust between these parties.

A user operates the shared card payment (SCP) system via a shared card payment software application executed on the user's mobile device. In the described embodiments, the shared card payment software application is a dedicated mobile application obtained by the user via a mobile application distribution store (such as Google Play Store or Apple Store). The shared card payment application allows the user to select, from the shared cards which have been successfully added to the user's registered account, a shared card payment account from which a payment is to be made at a payment device. The payment can be a cash withdrawal or a POS purchase performed at ATM or POS payment devices respectively, The payment devices of the shared card payment system are standard ATM or POS devices configured to interface with the user's mobile device for the purpose of obtaining the details of the payment account corresponding to the shared card selected by the user. Following authentication by the user at the ATM or POS device and verification by the card association entity that the user is authorized to perform the payment, processing of the transaction proceeds according to standard procedures for financial message generation and transmission. This allows the shared card payment system and process described herein to integrate with existing ATM and POS terminals, and with the current transaction processing systems deployed by issuers.

Authorization from the card owner is required in order for the user to make a payment using a particular shared card. Authorization involves the transmission of a real-time shared payment authorization request from the card association entity to the card owner. In the described embodiments, the shared payment request is delivered via the mobile network to the card owner's registered mobile phone device, however other embodiments may allow a card owner to authorize payments via Internet based communication (such as, for example, via email or an instant messaging program operating over a secure transmission protocol). Approval of the shared payment request by the card owner results in the of the corresponding shared card payment account for use by the user. Authorized access to the shared card payment account is granted to the user by the transmission, from the card association entity to the user's mobile device, of: an identifier representing the shared card payment account selected by the user in an encapsulated form, and a one-time password (OTP) security code, which permits a transaction to be performed with the shared card payment account. The user can enter the identifier and corresponding OTP code into the ATM or POS device in order to complete a cash withdrawal or POS payment using the selected shared card.

Interaction between the user mobile device and the payment device is based on QR code identifiers in the described embodiments. The shared card payment application displays the QR code such that the payment device is able to read the code and obtain the information required to perform the payment transaction with the shared payment card account. The skilled addressee will appreciate that other identifiers may be used in alternative embodiments to encapsulate the shared payment account information, such as barcodes or other sequences of symbols and/or characters. It is noted that the concepts described herein in relation to performing controlled access to shared payment accounts are equally applicable to such alternative embodiments.

The shared card payment system and process described herein therefore advantageously provide a platform for managing shared access to payment accounts that 1) allow a user to make payments with an account of a family member, or other individual, without the user possessing the physical card associated with the account, or having access to a device operating a digital wallet containing the account, 2) enable control to be exercised over access to a payment account that is shared between two or more individuals, by requiring real-time authorization of payment requests by the card owner, 3) maintain the security of a card owner's shared payment account by using an authentication process that encapsulates the account information and security PIN of the shared card, and 4) support the use of standard methods for ATM and POS based transaction processing, thus requiring minimal changes to the existing financial infrastructures of card association entities and issuing financial institutions.

### System

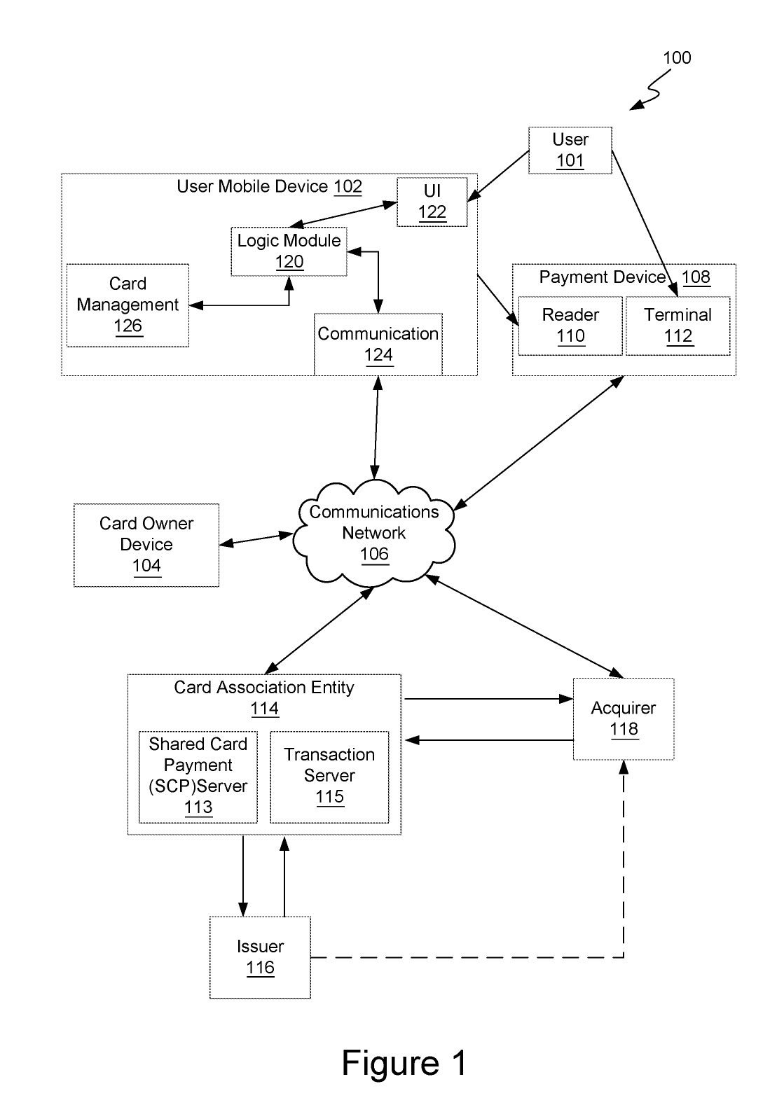

As shown in FIG. 1, the shared card payment (SCP) system 100 includes a user mobile device 102, such as a smartphone, tablet or portable computer, operated by a user 101 in communication with a card association entity 114 device via a communications network 106. The user 101 operates the user mobile device 102 for the purpose of making a payment with a payment account that is linked to the card association entity 114, where the payment account and associated card (such as a credit or debit card) are owned by a card owner with corresponding card owner device 104. The payment is made by the user 101 via a payment device 108, which includes a reader 110 configured to read or scan the user mobile device 102 in order to identify the account from which the payment is to be made, and a terminal 112 configured to accept security verification input that verifies the authorization of the user 101 to make a payment to the identified account. In the described embodiments, the payment device 108 is configured to communicate with the card association entity 114 and/or acquirer 118 via the communications network 106. In other embodiments, the payment device 108 can be configured to communicate directly with the acquirer 118 or card association entity 114, such as, for example, in the case of an ATM that is physically connected to the secure local network of a financial institution.

The user mobile device 102 executes a SCP application which facilitates the process by which the user 101 can select a shared card to make a payment, obtain authorization from the card owner of the associated shared payment account, and conduct the payment at a payment device. The SCP application of the described embodiments is a mobile application in the form of software modules including a user interface 122, a logic module 120, a communication module 124 and a card management module 126, as described below.

The user mobile device 102 receives authorization from the shared card payment server (SCP server) 113 of the card association entity 114 to make a payment from the payment account, where the authorization is determined based on communication between the SCP server 113 and the card owner device 104 via the communications network 106. In the described embodiments, the communications network 106 includes a plurality of different sub-networks. Specifically, communication between the user mobile device 102 and the card association entity 114 is conducted over local or wide area networks, via Internet data transfer protocols. Communication between the card owner device 104 and the SCP server 113 occurs over the telephone network, via SMS or standard voice call. The skilled addressee will appreciate that, in other embodiments, communication between the card owner device 104 and the SCP server 113 of the card association entity 114 may occur over Internet based communication networks 106, as facilitated by a software application executing on the card owner device 104.

The card association entity 114 further includes a transaction server 115 configured to communicate with the issuer 116 of the shared payment account in respect of a payment that is requested to be made using this account. The processing of payment transactions by the card association entity 114, and the communication occurring between the card association entity 114, the issuer 116, and the acquirer 118 is in accordance with standard financial payment system processes.

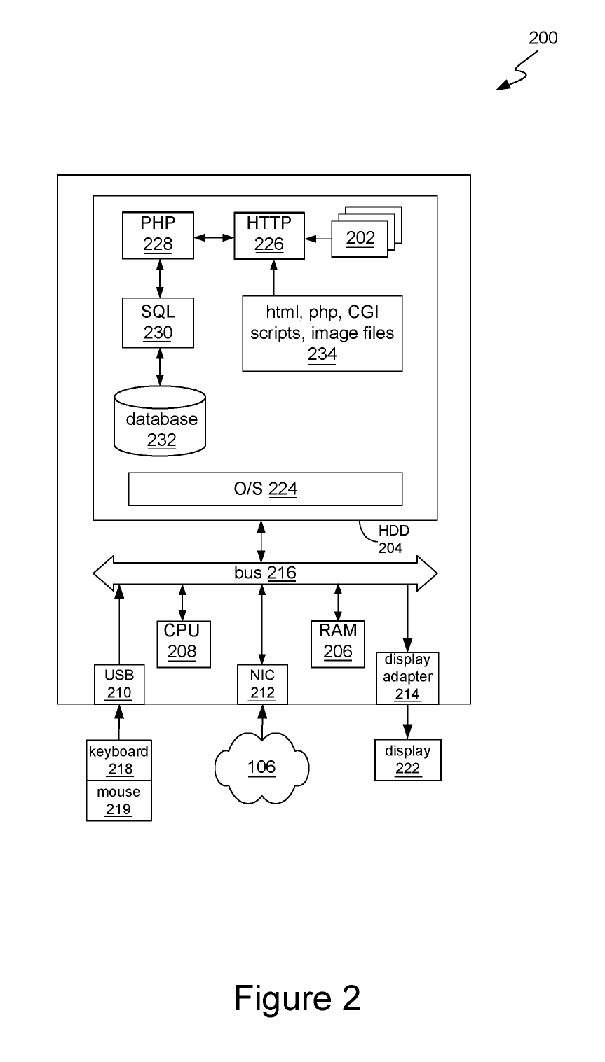

In the described embodiments of the SCP system, the user mobile device 102, card owner device 104, payment device 108, card association entity 114 devices (including the SCP server 113 and transaction server 115), acquirer 118 devices, and issuer 116 devices are standard computer systems 200 such as, for example, an Intel IA-32 based computer system, as shown in FIG. 2, and the processes 300, 600, 800, and 900 executed by the system 200 are implemented as programming instructions of one or more software modules 202 stored on non-volatile (e.g., hard disk or solid-state drive) storage 204 associated with the computer system. However, it will be apparent that at least parts of the aforementioned processes could alternatively be implemented as one or more dedicated hardware components, such as application-specific integrated circuits (ASICs) and/or field programmable gate arrays (FPGAs), for example.

The system 200 includes standard computer components, including random access memory (RAM) 206, at least one processor 208, and external interfaces 210, 212, 214, all interconnected by a bus 216. The external interfaces include universal serial bus (USB) interfaces 210, at least one of which is connected to a keyboard 218 and a pointing device such as a mouse 219, a network interface connector (NIC) 212 which connects the system 200 to a communications network 106, such as the Internet, and a display adapter 214, which is connected to a display device such as an LCD or LED panel display 222.

The system 200 also includes a number of standard software modules 226 to 230, including an operating system 224 such as Linux or Microsoft Windows, web server software 226 such as Apache, available at http://www.apache.org, scripting language support 228 such as PHP, available at http://www.php.net, or Microsoft ASP, and structured query language (SQL) support 230 such as MySQL, available from http://www.mysql.com, which allows data to be stored in and retrieved from an SQL database 232.

Together, the web server 226, scripting language module 228, and SQL module 230 provide the system 200 with the general ability to allow users of the Internet 220 with standard computing devices equipped with standard web browser software to access the system 200 and in particular to provide data to and receive data from the database 232.

However, it will be understood by those skilled in the art that the specific functionality provided by the system 200 to such users is provided by scripts accessible by the web server 226, including the one or more software modules 202 implementing the process 300, and also any other supporting scripts and data 234, including markup language (e.g., HTML, XML) scripts, PHP (or ASP), and/or CGI scripts, image files, style sheets, and the like.

In the SCP system and process the user 101 can withdraw cash from, or make a POS purchase with, the payment account linked to a card that is registered as shared respect to the user 101, subject to authorization from the card owner. The process of performing a shared card payment with the user mobile device 102 includes the steps of: generating payment card data representing a payment card linked to a payment account of a first individual (i.e. the card owner), where the payment card is linked to a card association entity 114 and a corresponding issuing financial institution 116, processing the payment card data to generate authorization request data, the authorization request data requesting authorization for a second individual to make a payment using the payment account of the first individual, transmitting the authorization request data to the card association entity 114 and receiving in response payment authorization data, said payment authorization data representing an indication of whether the payment is authorized, wherein, if the payment is authorized, the payment can be performed at a payment device 108 when a payment account identifier and a corresponding security code, both of the payment authorization data, are presented to the payment device 108.

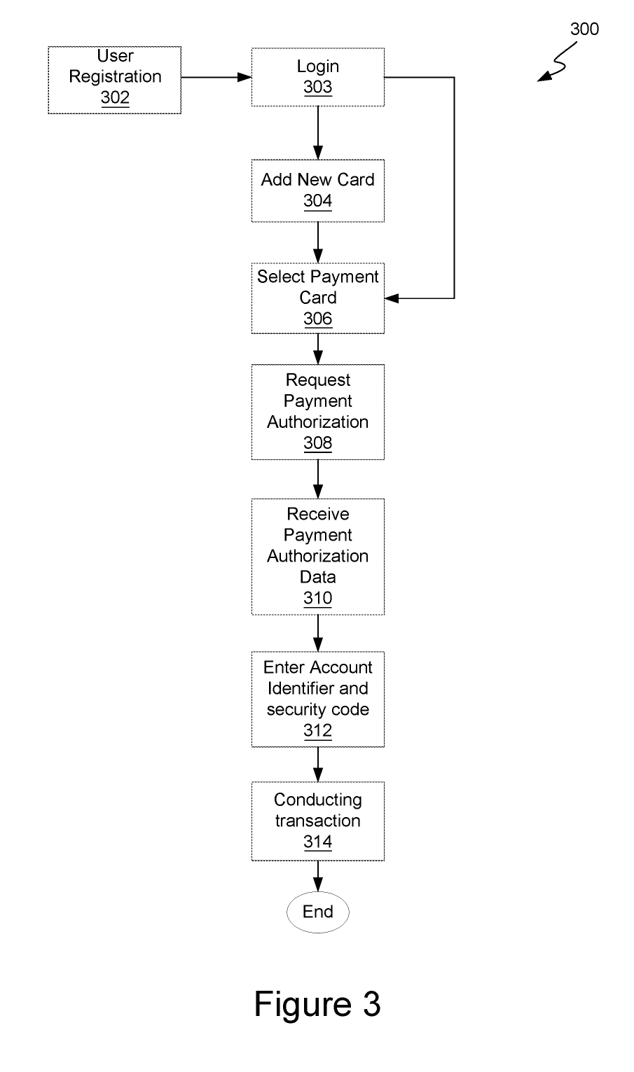

FIG. 3 illustrates the process 300 of performing a SCP transaction with the system 100. The user 101 first obtains the SCP application on the user mobile device 102 via a mobile software distribution platform (such as Google Play Store or Apple Store). New users register with the SCP system at step 302, allowing the user to login with their SCP account details at step 304. Logged in users can add a new shared payment card to their account (at step 304), and can select a previously added shared payment card to perform a payment at step 306. The user performs a SCP transaction by requesting authorization (at step 308), receiving data authorizing (or denying) the payment at step 310, entering the received account identifier and security information into the payment device, if the payment is authorized, at step 312, and conducting the transaction following standard procedures for using the particular payment device (at step 314).

### New User Registration

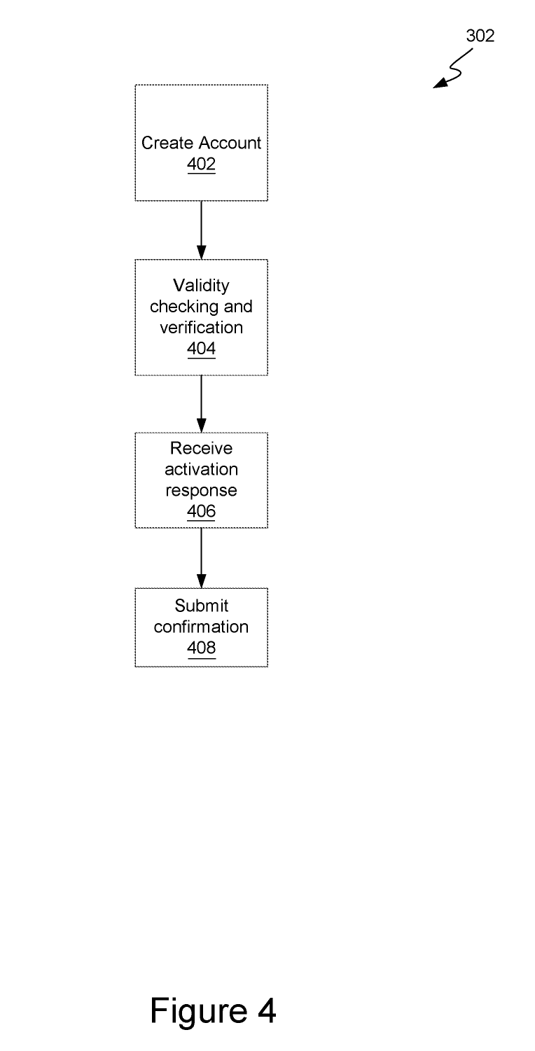

If the user 101 is a new user (i.e. has not previously registered with the SCP system), then user registration is performed at step 302. FIG. 4 illustrates the process of registering a new user with the SCP system. The registration process can be performed on the user mobile device 102 by the SCP application, or by using a generic web browser to access the corresponding registration webpages of the card association entity 114. To register a new account from the user mobile device 102, the user 101 interacts with the GUI elements rendered on the user mobile device 102 by the UI module 122 and selects to create a new account. During account creation (i.e. during step 402) the user 101 provides identification details including their full name, address, mobile telephone number, and email address. In some embodiments, the user 101 is required to also provide details of at least one payment account that is linked to a card associated with the card association entity 114. The user 101 provides login details including a username and a password for the account which are collectively used by the user 101 to access the SCP system following the completion of the registration process.

At step 404, the account details of the user 101 is transmitted to the card association entity 114, where validity checking and verification of the account information is performed. Specifically, the card association entity 114 performs cross-checking to ensure that the identity information submitted by the user 101 during the registration process corresponds to that within the customer records of the card association entity 114. In some circumstances, verification of the registration information provided by the user 101 involves transmission of the identity information to the issuer 116 corresponding to the payment card of the user 101. In some embodiments, the card association entity 114 is configured to record additional information from the user mobile device 102 during the transmission of the registration request of step 402. The additional information can include, for example, the IP address of the user mobile device 102, and one or more hardware identifiers which provide an indication of the identity of the user mobile device 102 based on the hardware components of the device. In such embodiments, the IP address of the registration request and the hardware identifiers of the user mobile device 102 are stored in the SCP server 113, and are used to compare corresponding IP addresses and hardware identifiers obtained from subsequent logins by the user 101 in order to prevent fraudulent access to the user's account.

At step 406, the user 101 receives an activation response generated by the card association entity 114. In the case that the registration information submitted by the user 101 in step 402 is valid, the activation response provides the user 101 with a visual indication of the validated registration details and prompts the user 101 to enter a one time password (OTP) in order to confirm registration with the system. The OTP is generated by the card association entity 114 and is transmitted via SMS to the mobile phone number nominated by the user 101 during registration. This ensures that the phone number nominated by the user 101 during account registration corresponds to a user mobile device 102 (i.e. a smartphone in the described embodiments) which the user 101 has access to for the purpose of operating the SCP system. At step 408, the user 101 confirms the registration of their identification details and their corresponding user mobile device 102 by transmitting the OTP to the card association entity 114. In the described embodiments, transmission of the OTP is performed by the telephone network through a SMS or by voice call.

If the registration information provided by the user 101 is determined to be valid by the card association entity 114, then a new SCP account is registered by the storage of the user 101 identification details in the SCP server 113. Specifically, the username, password and payment card information are stored within the non-volatile storage components 204 of the SCP server 113 in encrypted form. A hashing function, such as SHA-1, is applied to the plaintext of the password to produce a ciphertext, which is subsequently stored as described above, in order to protect against the exposure of the account in the event of a security breach at the card association entity 114 devices.

### User Login

Following the successful registration of an account with the SCP system, the user 101 accesses the SCP system by a login process, at step 303. The user 101 selects a “login” option on the GUI display rendered by the UI module 122 executing on the user mobile device 102, and is presented with a login form requesting the details of the user 101, as determined during the registration process of step 302. The user provides, at least, the username and password corresponding to their registered SCP account and submits a login request to the card association entity 114. The login request is processed by the SCP server 113, which performs validation of the username and password by searching for the provided username among the usernames of one or more other registered users of the system 100. If a match is found, hashing is applied to the provided password and a comparison is performed between the resulting ciphertext and that of the registered user with the corresponding username. If the ciphertexts of the passwords match, then the login is successful, and a login success response is transmitted from the card association entity 114 to the user mobile device 102. Otherwise, the login attempt is rejected and the user 101 is prompted with an option to enter alternative login details.

### Adding a New Payment Card

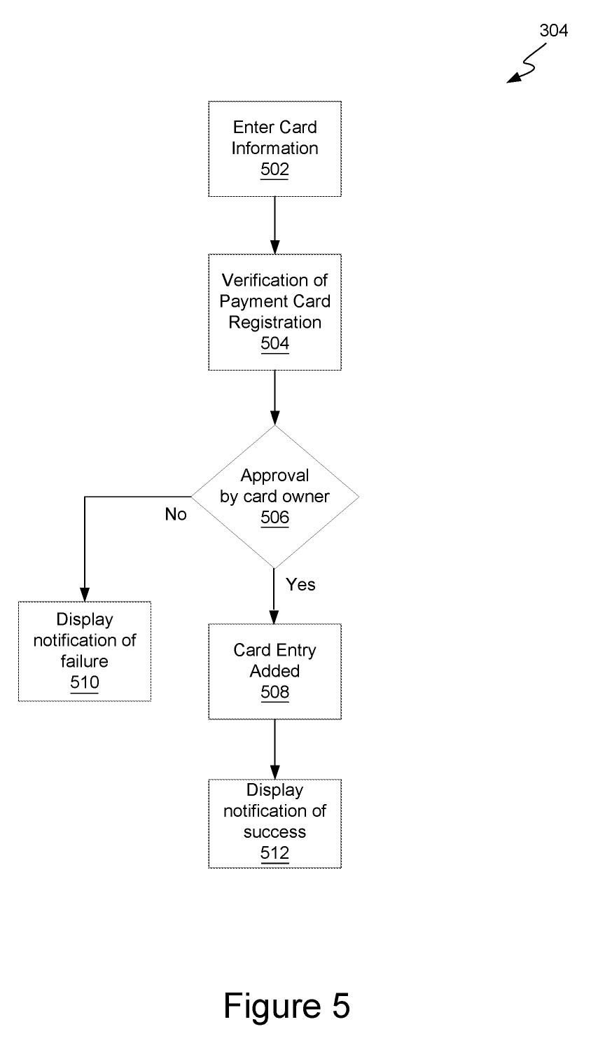

When logged into the SCP system, either by the login process of step 303 described above or following the successful registration of a new user account in step 302, the user 101 can elect to add a new payment card to their SCP account (at step 304). If successful, the new payment card is registered as a shared payment card in respect of the user 101, such that payments can be made from the payment account associated with the shared payment card by user 101, subject to authorization from the card owner. FIG. 5 illustrates the process by which a new card is added to the set of shared payment cards registered in respect of the user 101. At step 502, the user 101 enters details corresponding to the new payment card to be added into the SCP application via GUI elements rendered on the user mobile device 102. The information entered by the user 101 includes the card number, an indication of the issuing financial institution of the payment account associated with the card, and the card Interbank Card Association (ICA) value. In some embodiments, the SCP user 101 is also prompted to enter the details of the card owner, including at least one of their full name, address, and mobile phone number. A request to register the new payment card is transmitted from the user mobile device 102 to the card association entity 114 for processing by the SCP server 113.

At step 504, the SCP server 113 receives the request to register the new payment card and verifies the registration by processing at least one of: the payment card number, the indication of the issuing financial institution, and the card ICA value to generate a registration request notification, which indicates the intention of the user 101 to register the new payment card as a shared payment card from which they are able to make payments. The registration request notification contains the new payment card information and the identification information of the user 101, as registered within the card association entity SCP server 113. In embodiments where the user 101 is required to enter details of the card owner, these card owner details are also included in the registration request notification.

The registration request notification is transmitted to the issuer 116 in an encrypted and/or digitally signed form such that the issuer 116 is able to verify the authenticity of the request. The issuer 116 processes the registration request notification to obtain the identity of the card owner associated with the new payment card for which registration as a shared payment card is requested by the user 101. This involves a search of the customer record database within the issuer 116 devices for the identity information of the customer (i.e. the card owner) corresponding to the new payment card. If the card owner is found, then a registration confirmation request is transmitted to the card owner by a predetermined means. In described embodiments, the issuer 116 sends the registration confirmation request to the card owner by email, based on the card owner's recorded registered email address to indicate that the user 101 as requested to add the new payment card to the SCP system, and to request the card owner's approval or rejection of this request. In other embodiments, the registration confirmation request may be sent to the card owner by SMS, voice call, or by written correspondence. In some embodiments, the issuer 116 performs verification of the card owner details included in the registration request notification with the identity information of the card owner retrieved from the database. This verification step may be performed prior to the transmission of a registration confirmation request to the card owner. The issuer 116 can be configured to automatically, and without input from the card owner, reject registration request notifications containing card owner details that do not match the corresponding details retrieved from the database. In these embodiments, threshold based checking of the card owner details may be performed to ensure that legitimate registration requests are not rejected due to trivial mistakes by the user 101 (such as, for example, the misspelling of a single letter within the card owner's name).

At step 506, the card owner responds to the registration confirmation request to either approve or reject the registration of the new payment card by the user 101. The response of the card owner is received by the issuer 116 and is encapsulated within a registration request response. The registration request response is transmitted back to the card association entity 114 for the purpose of indicating the approval or rejection of the registration of the payment card as a shared payment card in respect of the user 101. The card association entity 114 processes the indication of approval or rejection of the registration and, if the card owner approved the registration, generates a registration key which uniquely represents the registration of the new payment card as a shared payment card in respect of the user 101 (at step 508). In the described embodiments, the registration key is stored within a shared payment card list data structure of the SCP server 113 which lists the payment cards that are registered in respect of user 101. The card association entity 114 generates registration confirmation data indicating whether the card owner has approved or rejected the registration of the new payment card by the user 101. The registration confirmation data is transmitted to the user mobile device 102, allowing the user mobile device 102 to display the registration confirmation data for the purpose of informing the user 101 of the successful registration (at step 512), or alternatively of the rejection (at step 510), of the new payment card.

### Selecting a Payment Card

At step 306, the user 101 operates the SCP system to perform a SCP transaction by firstly selecting a payment card from the set of one or more shared payment cards that are registered in respect of the user 101. The user 101 interacts with GUI elements displayed on the user mobile device 102 to begin the card selection process. A list of available shared payment cards for the user 101 is obtained from the SCP server 113 of the card association entity 114 by the communications module 124. The shared payment card list data is transferred from the card association entity 114 to the user mobile device 102 in encrypted form on request by the SCP application. The logic module 122 determines the frequency with which the shared payment card list requests are sent to the card association entity 114. In the described embodiments, a shared payment card list request is transmitted when the user 101 opts to select a payment card in order to ensure that the payment cards presented to the user 101 accurately reflect all the shared payment cards which are registered with respect to the user 101 at that particular time. In other embodiments, the logic module 120 may schedule periodic updates of the shared payment card list at various times when the user 101 is using the SCP application. The logic module 120 directs the transfer of the shared payment card list from the communication module 124 to the card management module 126. The card management module 126 decrypts the shared payment card list data and generates, for each shared payment card, payment card data representing the payment card and the associated payment account of the card owner.

The UI module 122 reads the generated payment card data from the card management module 126 and displays the shared payment cards to the user 101. In the described embodiments, the details of each shared payment card are displayed to the user 101, including the card number, the issuer 116 of the card, and the corresponding card owner. The user 101 operates the user mobile device 102 to select a shared payment card to be used for making the payment transaction. The selection results in the payment card data of the selected payment card being transmitted to the logic module 120 by the card management module 126.

### Authorization of a SCP Request

### i) Generation of an Authorization Request by the User Device

At step 308, the SCP application processes the selected payment card data to generate an authorization request enabling the card owner to authorize the user 101 to perform the payment transaction with the selected card. The authorization request is initiated by the logic module 120 of the SCP application. An authorization request messages created by the logic module 120 based, at least, on 1) the payment card data, 2) transaction information data, and 3) user identification data. The transaction information data indicates the details of the payment to be performed by the user 101 with the payment card. In described embodiments, the transaction information data includes a payment amount representing the maximum value of the payment transaction to be performed by the user, and a currency in which this amount this weekend. The transaction information data is generated by the logic module 120 based on transaction details supplied by the user 101 through the GUI elements of the user mobile device 102.

In the SCP system described herein, the user 101 is permitted to transact any amount that is less than or equal to the specified (capped) payment amount in the transaction information data. For example, a user 101 seeking to purchase groceries with the selected shared payment card may request authorization from the card owner before knowing the exact value of the grocery items chosen for the purchase (such as, for example, while they are waiting in the checkout line). In this case, the user specifies a payment amount which corresponds to an estimate of the maximum value of the purchase in order to obtain authorization from the card owner. The payment can therefore be “preauthorized” by the card owner despite the user not knowing the exact transaction value, and the transaction can be subsequently performed by the user provided that the actual purchase amount does not exceed the authorized estimated amount.

The authorization request also contains data identifying the user 101, including one or more of the name, address, telephone number, email, and username of the user 101. The logic module 120 generates the authorization request data in a predetermined form (such as, for example, an authorization request message known by the card association entity 114) and transmits the authorization request via the communications module 124 to the card association entity 114.

### ii) SCP Authorization by the Card Association Entity and Card Owner

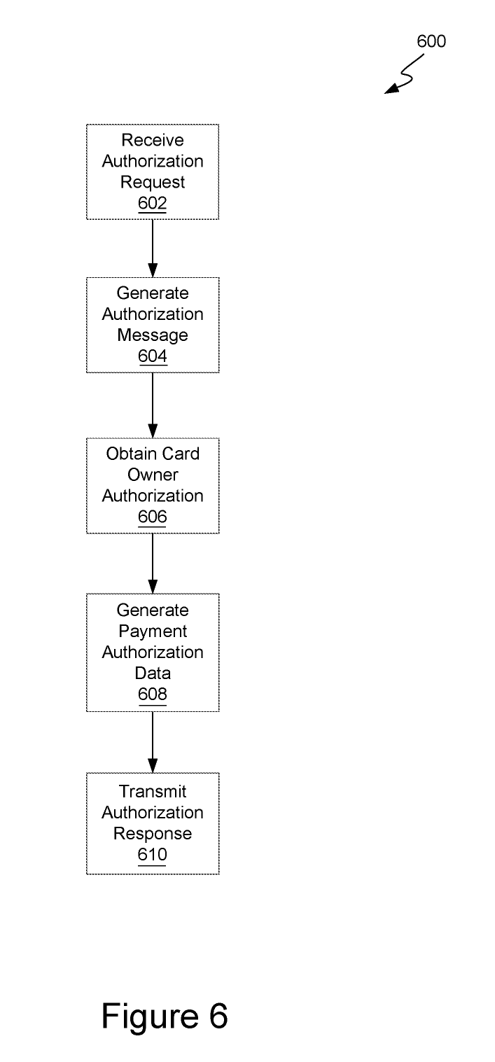

FIG. 6 illustrates the process by which the payment is authorized by the SCP system. At step 602, the authorization request data is received by the SCP server 113. The SCP server 113, at step 604, processes the authorization request data to generate card owner notification data representing a notification of the user's request for authorization to make the payment. The card owner notification data is transmitted to the registered mobile phone device of the card owner 104 by the communications network 106. In some embodiments, the contact information of the card owner is stored in an entry within the shared payment card list of the user 101 within the SCP server 113, allowing the authorization request to be communicated to the card owner mobile device 104 directly without involving the issuer 116. In other embodiments, the card association entity 114 sends a request to the issuer 116 to obtain the contact information of the card owner mobile device 104.

The card owner notification data is transmitted, at step 606, via an SMS containing details of the user's request to perform a payment with the selected payment card for the purpose of allowing the card owner to authorize or deny this payment. The card owner notification sent to the card owner mobile device 104 includes the authorization request message, as described above, in addition to validation information which may be used by the card owner to authorize the payment request. The payment request is authorized or denied by the card owner via a reply to the SMS, or by other means. For example, the card owner notification data may indicate a toll-free phone number which the card owner may call, and a corresponding code that can be entered by the keypad during the call to authorize the transaction. Card owner authorization data, either in the form of an SMS reply or other data, indicating the card owner's authorization or denial of the payment request is received by the card association entity 114. If no card owner authorization data is received by the card association entity 114 (i.e. if the card owner does not respond to the request) within a particular predetermined period of time, then the request is automatically denied and the authorization process proceeds accordingly as described below.

iii) Creating the SCP Account Identifier and Security Code Token Pair

At step 608, the card owner authorization data is processed by the SCP server 113 to generate payment authorization data, which includes an indication of whether the payment is authorized or denied. If the payment is authorized by the card owner, the SCP server 113 also generates i) a payment account identifier representing the information needed to complete a transaction with the payment account for which the payment is authorized, and ii) a security code corresponding to the payment account identifier, in accordance with the processes described below.

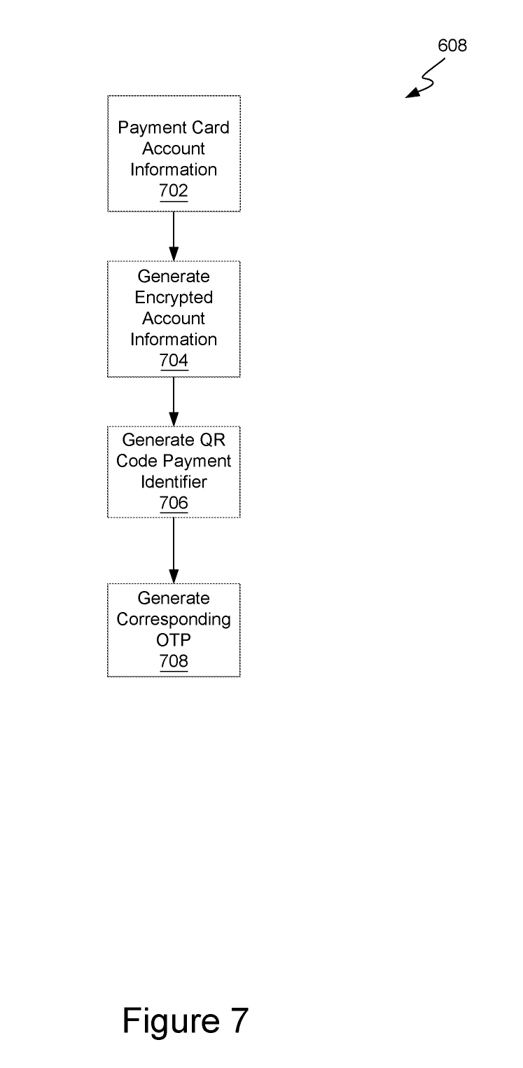

FIG. 7 illustrates the process by which payment authorization data is generated by the card association entity 114 in response to receiving card owner authorization data that indicates the authorization of the payment transaction. At step 702, the information of the payment account corresponding to the selected payment card is retrieved by the card association entity 114. In the described embodiments, the payment account information is obtained from the issuer 116 on request by the card association entity 114. In alternative embodiments, the payment account information is stored within the SCP server 113, such as within the list of registered shared payment cards for the user 101.

The payment account information reflects a set of variables that are typically encoded in tracks one and two of a standard financial magnetic stripe card (such as an ATM card) according to the ISO/IEC 7813 protocol. This information includes the card owner name, the primary account number (PAN), the expiration date of the card, a service code, and a discretionary data value, such as a PIN verification key indicator, a PIN verification value, a card verification value (CVV), or a card verification code (CVC). At step 704, encryption is applied to the payment account information using a symmetric key encryption algorithm, where the key is known by both the card association entity 114 and the payment device 108 for which the transaction is performed on (as described below).

At step 706, a payment account identifier is generated in the form of a machine-readable optical label containing the encrypted account information. In the described embodiments, the payment account identifier is a quick response (QR) code that is dynamically generated by the SCP server 113 according to the ISO/IEC 18004:2015 standard. Encoding of the account information proceeds with using version 10 in binary mode, where 8 bits used to encode each character in accordance with ISO 8859-1. In the described embodiments, the code error correction level is set to high (‘H’) allowing restoration of approximately 30% of the encoded codewords via Reed-Solomon error correction. This supports the encoding of up to 174 characters representing the encrypted payment account information, rendered in a 57×57 module format.

Other embodiments of the system and process may utilize different encoding techniques for the generation of the QR code identifier. Specifically, the version and mode of the encoding scheme can be configured based on the amount of data produced by the encryption process. For example, version 40 binary encoding allows for a larger number (i.e. 1264) of ASCII text characters to be encoded, which may be beneficial when account information encryption is performed using a technique which produces long ciphertext representations (such as asymmetric encryption with large key sizes). For the same level of code error correction, this results in payment account identifiers of a larger data size and may therefore require increased bandwidth for transmission to the user mobile device 102. In other embodiments, the encoded payment account information may be supplemented with redundant information which serves to visually indicate to the user that the code represents a shared payment card (such as the display of the name of the card association entity and/or card owner).

A different QR code based identifier is generated for each unique payment transaction performed even where the payment account information (i.e. the selected payment card) remains the same, by including a transaction identifier in the data encoded within the QR code. The QR code is only valid for a pre-determined duration. The transaction identifier is maintained by the SCP server 113 and, in the described embodiments, is an integer that is incremented each time a shared payment transaction is performed by a user of the SCP system.

At step 708, the card association entity 114 generates a security code in the form of an OTP based on the payment account information. In the described embodiments, the OTP is a 4-digit number generated by using an OTP generation key to encrypt the account PAN value in combination with a seed value which changes dynamically but predictably (such as, for example, the number of 30 second periods having elapsed since a particular reference time). This ensures that such there is no relationship between the generated OTP for the authorized payment and the actual PIN value of the shared card on which the payment is to be made. The card association entity 114 generates a new OTP for the shared payment card, and stores this value within a “SCP token vault” data structure residing on the SCP server 113.

During requests to authenticate a SCP transaction at an ATM or POS device (as described below), the ATM or POS payment device can be configured to validate the OTP code using a specialized hardware device. For example, a payment device (such as an ATM) can be configured to use a hardware security module (HSM) to store the OTP generation key and the seed value, and to perform the encryption process. PC based payment devices (such as POS stations) can be configured to utilize one or more of the associated computing devices 200 for the purpose of performing code validation, either within a software application or a dedicate hardware cryptoprocessor, such as a trusted platform module (TPM). The TPM can be configured to validate the OTP code, as an alternative to, or additionally with, other hardware devices, such as a database 232 or other local storage devices. Alternatively, the ATM or POS payment device 108 can be configured to request remote validation of the OTP code from the card association entity's SCP server 113, as described below. Generally, during a transaction, the OTP code is validated, then the OTP code is transmitted to an appropriate acquiring channel and subsequently, the OTP code is associated with acquiring information like a QR code.

The QR identifier and corresponding OTP security code together form a “token pair” which functions to prevent the exposure of account information in shared payment environments, and thus reduce the likelihood of the card owner's data being stolen and subsequently used for fraudulent purposes. That is, the combination of the QR and OTP codes encapsulate the shared card account PAN and security PIN during the exchanges between the card association entity 114 and the user mobile device 102 that enable a shared payment to be performed, while maintaining compatibility with the existing processes for handling financial transactions at the back-end (i.e. between the issuer 116 and the card association entity 114). Additionally, since the QR identifier and OTP code are domain specific (i.e. they are uniquely created for the purpose of using the SCP system) the card owner's underlying account, and any other tokens associated with this account, are protected in situations where the identifier and code are compromised.

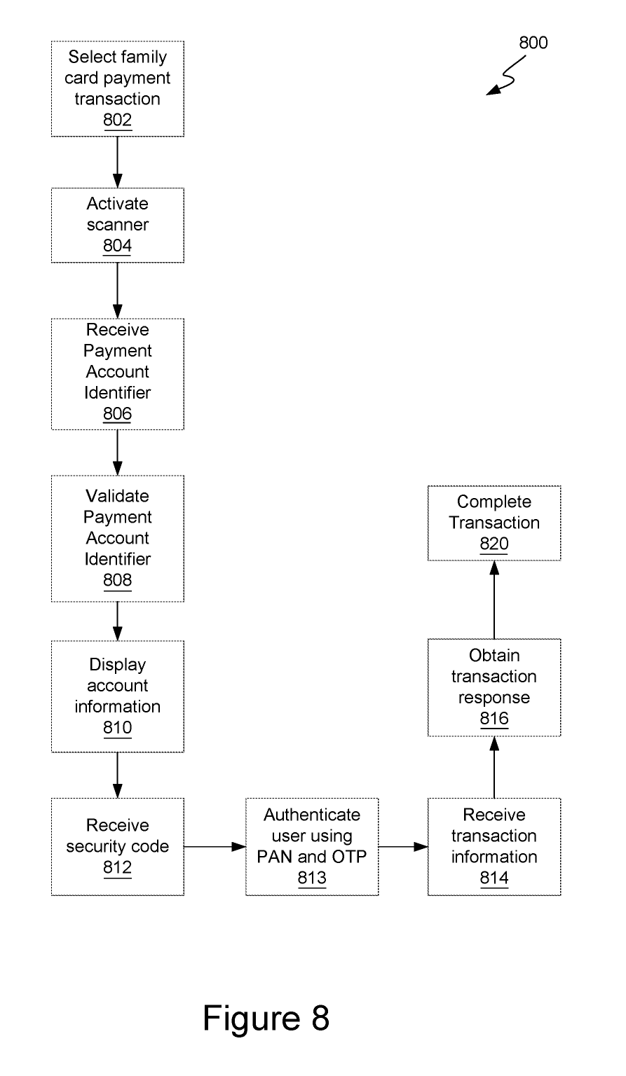

In alternative embodiments, the SCP system 100 can be configured to allow the use of the card owner's real payment card PIN as the security code. The card owner can permit the shared payment transaction to be performed at a payment device using their PIN value as the security code during the authorization process of step 606 (see FIG. 6). In this case, a representation of the card PIN value is transmitted from the issuer 116 to the card association entity 114, allowing the SCP server 113 to store the PIN representation for the shared payment card within the SCP token vault data structure. The PIN value representation is stored in addition to any existing OTP code generated for the shared payment card in respect of the payment request. During authentication (i.e. at step 813 of FIG. 8 described below), the user 101 can elect to enter either the generated OTP or the card owner's actual PIN code as the security code, for the purpose of achieving authentication to perform a payment transaction with the payment account. Generally, the OTP authentication is most desirable as different cards have different PIN values. The PIN values can be mapped/associated using known methods.

In the described embodiments, the QR code payment identifier and the OTP security code are set to expire a predetermined period of time (such as, for example, 5 minutes) after generation. On expiry the identifier and code become unusable for the purpose of performing the payment transaction. The payment account identifier and security code token pair data are stored in the SCP server 113 within the SCP token vault data structure, with a link to the corresponding authorization request data for which the token pair is generated (i.e. the payment card, transaction information, and user identification information as described above). The payment authorization data (i.e. the token pair) and the corresponding authorization request data are removed from the SCP server 113 on expiry, or on the completion of a successful payment transaction in respect of the authorization request (as described below), whichever occurs earliest.

At step 610, the payment authorization data is transmitted to the user mobile device 102 by the card association entity 114, such that the authorized shared card payment can be performed at the payment device 108 when the payment account identifier and the security code are presented to the payment device 108. Alternatively, when the payment is not authorized, the payment authorization data contains an indication of the denial of the payment request.

With reference to FIG. 3, at step 310 the communication module 124 of the SCP application receives the payment authorization data from the card association entity 114. The logic module 120 processes the payment authorization data to interpret the indication of whether the payment request was authorized or denied by the card owner. The logic module 120 directs the UI module 122 to display a corresponding notification to the user 101 via the user mobile device 102 GUI elements. If the payment request is authorized, the user 101 is able to direct the SCP application to selectively display the QR code based payment identifier and/or the security code onto the display 222 of the user mobile device 102, at step 312. For example, the SCP application can be configured to display the QR code separately to the OTP code, such that the QR code can be viewed and scanned by another individual (such as a cashier) without compromising the security of the transaction. At step 314, the QR code payment account identifier and corresponding OTP code are used by the user 101 to complete the payment transaction at the payment device 108, as described below.

### Conducting a Payment at a Payment Device

The described embodiments of the SCP assessment process allow the user 101 to make a payment with a registered shared payment card in the form of an ATM withdrawal or POS purchase transaction. The user 101 interacts with a payment device 108 for the purpose of completing the payment, where the payment device 108 is an ATM device or a POS device (such as a PC terminal configured to execute a POS software application) according to the respective type of payment transaction performed by the user 101.

A payment device 108 of the SCP system 100 is configured to perform a shared card payment transaction by: receiving from the user mobile device 102 i) transaction information data representing the payment transaction requested by user 101 in respect of the payment account, and ii) payment authorization data, including an indication that the payment transaction is authorized, processing the payment account identifier and the security code to generate authentication data indicating whether the user 101 is permitted to transact the payment account, transmitting, if the user 101 is permitted to transact the payment account, the payment account identifier, the security code and the transaction information data to the card association entity 114, where the card association entity 114 is configured to provide response data by processing the payment account identifier, the security code and the transaction information data, and processing the response data received from the card association entity 114 to complete the transaction.

In the described embodiments, the payment authorization data includes a payment account identifier representing the information needed to complete a transaction with the shared payment account of a card owner and a security code corresponding to the payment account identifier. FIG. 8 illustrates the process by which a payment transaction is made and a payment device 108 in accordance with the described SCP system 100. At step 802 the user 101 initiate a SCP transaction on the terminal 110 of the payment device. For example, in embodiments where the payment device is an ATM, the user 101 interacts with an input device of the terminal 110 (such as a touchpad, keypad, screen, or other peripheral) to select the SCP functionality mode of operation. Similarly, in embodiments where the payment device 108 is a POS device the SCP transaction mode is initiated at the terminal 110 by the merchant or other delegated person (such as a cashier, for example).

At step 804, the payment device 108 activates a reader on 112 configured to read a payment account identifier displayed by the user mobile device 102. In described embodiments, the reader 112 is a QR code scanner configured to interpret a QR code account identifier displayed on the user mobile device 102. For example, the reader 112 of an ATM device may be a NCR SS22e 2D barcode scanning module configured to read QR codes of the particular version and data mode used by the SCP server 113 as described above. At a POS payment device, the reader 112 may be a conventional 2D POS barcode scanner such as a laser scanner, a CCD scanner, or a camera based scanner. The reader 112 is locally connected to the terminal 110 of the ATM or POS device. The scanned image data produced by the reader 112 is transmitted to the terminal 110 via an application specific communications interface, such as for example the RS-232 serial interface, or other proprietary interfaces used in POS and/or ATM systems.

The reader 112 of the payment device 108 receives the QR code payment account identifier from the user 101, at step 806. The reader 112 scans the QR code and transmits the scanned QR code data to the terminal 110. The terminal 110 is configured to validate the scanned QR code data, at step 808, to ensure that the QR code represents valid financial payment account information. In the described embodiments this includes performing the decryption steps necessary to recover the card payment account details from the ciphertext encapsulated within the QR code (as described above).

At step 810, the payment device 108 displays the financial payment account information details on the terminal 110 of the device. In some embodiments, the payment device 108 is also configured to display details of the card owner. For example, the ATM screen or POS PC monitor of the terminal 110 may be configured to display the PAN, card owner name and issuer organization name to the user 101. The user 101 confirms the payment card and/or card owner information by operating the terminal 110. At step 812, the user 101 is prompted to enter the security code corresponding to the payment identifier. In accordance with the processes described hereinabove, the security code entered by the user 101 may be in the form of an OTP or the PIN of the shared payment card.

At step 813, the payment device 108 is configured to process the payment account information and the OTP code to generate authentication data indicating whether the user 101 is permitted to transact the payment account. Specifically, the authentication process determines whether the user 101 is permitted to perform a transaction with the shared payment account represented by the QR code identifier, based on prior authorization obtained from the card owner. In the described embodiments, the payment device 108 can be configured to perform the authentication process locally using a HSM which stores the OTP generation key and the seed value used by the SCP server 113 to generate the OTP code. The HSM encrypting the PAN extracted from the QR code data with the OTP generation key and seed value to produce a candidate OTP code, which is compared to the OTP provided by the user 101. If the candidate and provided OTP codes match, then the user 101 is authenticated.

Alternatively, the payment device 108 can be configured to request authentication of the token pair by the SCP server 113. The extracted PAN and presented OTP values are securely transmitted to the card association entity 114 via a local network (such as in the case of an ATM payment device) or a wider area communications network 106 (such as for a merchant POS terminal). Specifically, is data transmitted from the payment device 108 to the card association entity 114 using the NCR Direct Connection (NDC) communication protocol. The SCP server 113 performs a lookup operation on the SCP token vault data structure to determine whether the PAN and OTP provided to the payment device match the corresponding stored values. The SCP server 113 returns a positive authentication response indicating that the user 101 is authenticated to transact the account. Otherwise, the user 101 is not authenticated and a negative response is returned to the payment device terminal 110.

If the user 101 is authenticated to transact the shared payment account, at step 814 the terminal 110 prompts the user 101 to enter transaction information relating to the payment that is to be made. The transaction information includes the amount of the withdrawal or POS purchase depending on the type of payment.

At step 816, the payment device 108 transmits the payment authorization data and the transaction information to the card association entity 114. The processing of the SCP transaction by the card association entity 114 includes the steps of: receiving the payment authorization data, including the payment account identifier for the shared payment card and the OTP code corresponding to the payment account identifier, and the transaction information data representing the payment transaction requested by the user 101, processing the payment authorization data and the transaction information data to produce validity data indicating whether the payment transaction specified by the transaction information data can be validly performed, based whether there is prior authorization by the card owner, generating, if the payment transaction is valid, financial transaction data representing a standard financial transaction message for conducting the payment transaction, transmitting the standard financial transaction message to the issuing financial institution for processing, and receiving corresponding response data indicating the success or failure of the payment transaction, generating, if the response data indicates a success of the payment transaction, shared payment transaction record data indicating that the payment transaction has been performed with the payment card, and transmitting the response data to the payment device to enable completion of the payment transaction.

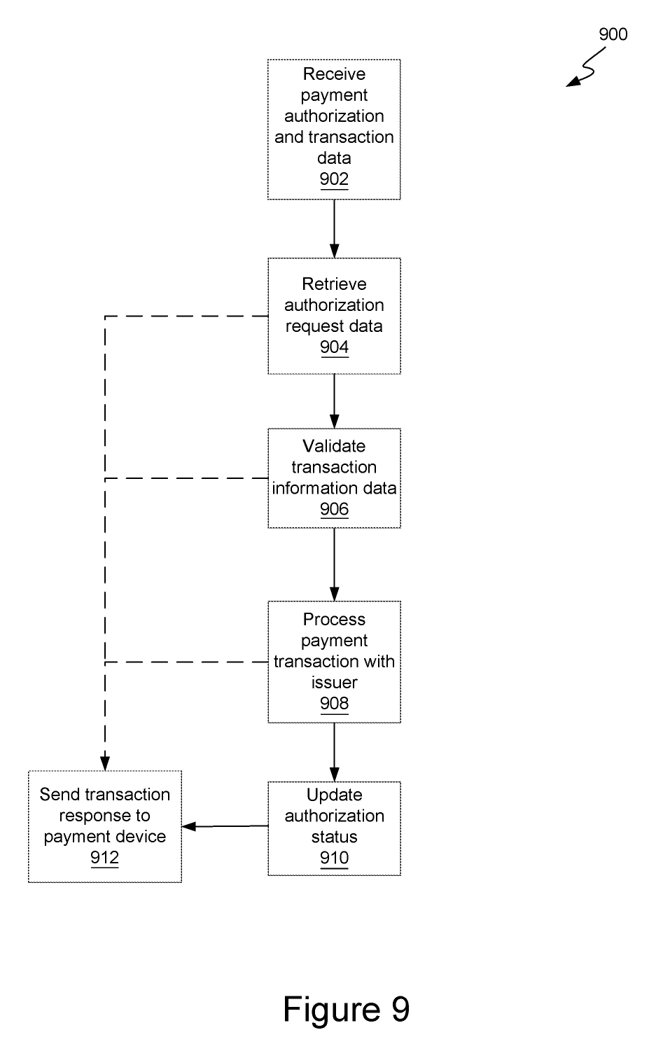

As shown in FIG. 9, following the reception of the payment account identifier, security code, and transaction information from the payment device 108 (at step 902), the card association entity 114 uses the identifier and security code token pair to search the SCP token vault and retrieve the corresponding authorization request information from the SCP server 113 (at step 904). The authorization information retrieved includes the payment card data; the transaction information data indicating details of the payment transaction authorized to be performed by the user 101, and the identification data identifying the user 101. The identity information of the card owner is also retrieved in embodiments where this information is stored by the card association entity 114.

The transaction information received from the payment device 108 is verified in respect of the corresponding transaction information included within the authorization request data retrieved by the SCP server 113. In described embodiments, the SCP server 113 checks that the payment amount that is specified in the transaction information is less than or equal to the payment amount authorized by the card owner. If the payment transaction amount satisfies this criteria then, at step 908, the SCP server 113 transmits the payment card information, card owner information, and transaction information to the transaction server 115 which executes the financial transaction.

The transaction server 115 is configured to generate data representing a standard financial transaction according to the ISO 8583 message protocol, and this ISO 8583 transaction data is transmitted to the issuer 116 for processing. The transaction is created in the name of the card owner, and processing proceeds according to the conventional steps for executing and ISO 8583 financial transaction request.

The transaction server 115 receives issuer response data from the issuer 116 in respect of the request to perform the ISO 8583 transaction. If successful, the card association entity 114 records the completion of the SCP transaction in the SCP server 115, and removes the entry in the authorization request data structure corresponding to the payment account identifier and security code pair. The issuer response data is forwarded to the payment device 108, at step 912, indicating the success of the ISO 8583 transaction for the shared payment card. Alternatively, if the transaction is denied by the issuer 116, or the transaction information provided by the payment device 108 indicates a transaction value which exceeds the authorized limit, or corresponding authorization request data cannot be obtained for the payment account identifier and OTP code token pair (indicating that the user 101 is not permitted to perform a SCP transaction with respect to the payment card), then a response indicating the failure of the transaction is sent to the payment device 108 directly following steps 908, 906, or 904 respectively.

The payment device 108 receives the transaction response data from the card association entity 114 at step 820 and finalizes the payment transaction. If the response indicates that the payment transaction was performed successfully by the issuer 116, then finalization of the payment transaction involves the approval of the ATM withdrawal or POS purchase. Otherwise, the withdrawal or POS purchase is denied. At step 910 a notification of the payment transaction completion status is provided to the user 101 via an output device of the terminal 110 (such as, for example, a display screen).

Many modifications will be apparent to those skilled in the art without departing from the scope of the present disclosure.

Throughout this specification, unless the context requires otherwise, the word “comprise”, and variations such as “comprises” and “comprising”, will be understood to imply the inclusion of a stated integer or step or group of integers or steps but not the exclusion of any other integer or step or group of integers or steps.

1. A data processor implemented process for making a payment from a shared payment card, the process being executed by at least one processor, and comprising:
generating payment card data representing a payment card linked to a payment account of a first individual, the payment card linked to a card association entity and a corresponding issuing financial institution;
processing the payment card data to generate authorization request data, the authorization request data requesting authorization for a second individual to make a payment using the payment account of the first individual; and
transmitting the authorization request data to the card association entity and receiving, in response, payment authorization data, the payment authorization data indicating whether the payment is authorized, wherein if the payment is authorized, the transaction can be performed at a payment device when a payment account identifier and a corresponding security code, both of which are included in the payment authorization data, are presented to the payment device.

2. The shared card payment process of claim 1, wherein the payment card data includes an indication of one or more of the card number, the card association entity, and identification information of the first individual.

3. The shared card payment process of claim 1, wherein the payment card data is generated based on a selection of the payment card from one or more shared payment cards, wherein each of the one or more shared payment cards are registered with their corresponding card association entity as a shared payment card in respect of the second individual, and wherein the process of registering a candidate payment card as a shared payment card in respect of the second individual comprises:
transmitting, to the card association entity, a request to register the candidate payment card; and
receiving registration confirmation data from the card association entity that indicates, when the registration of the candidate payment card as a shared payment card is approved, that the candidate payment card is a registered shared payment card, wherein the request to register the candidate payment card includes at least one of the card number, an indication of the issuing financial institution, and the card ICA value of the candidate payment card.

4. (canceled)

5. (canceled)

6. (canceled)

7. The shared card payment process of claim 1, wherein the authorization request data includes the payment card data, transaction information data indicating details of the payment transaction to be performed by the second individual, and identification data identifying the second individual, wherein the transaction information data includes a value of the payment and a currency of the payment, and wherein the data identifying the second individual includes one or more of the name, address, telephone number, email, and username of the second individual.

8. (canceled)

9. (canceled)

10. The shared card payment process of claim 1, wherein the payment identifier is a QR code generated by the card association entity and containing the information of the payment account of the first individual, and wherein the information of the payment account of the first individual includes one or more of i) the name of the first individual, ii) a Personal Account Number (PAN) of the payment account, iii) an expiration date of the payment card, iv) and a verification value of the payment card.

11. (canceled)

12. The shared card payment process of claim 1, wherein the security code is one of the PIN code of the payment card and a one time PIN (OTP) code, wherein the OTP is generated dynamically by the card association entity using an encryption algorithm with an associated OTP generation key to encrypt the PAN value in combination with a seed value, and wherein the payment account identifier and the security code operate as a token pair encapsulating the PAN of the payment account and the PIN of the payment card during the exchanges of data between the card association entity and the second individual in relation to the payment.

13. (canceled)

14. (canceled)

15. The shared card payment process of claim 1, wherein the payment account identifier and security code expire after a predetermined period of time, such that, once the payment account identifier and security code have expired, the payment transaction cannot be performed at the payment device when the payment account identifier and the security code are presented to the payment device.

16. A user device, including at least one computing device being configured to make a payment from a shared payment card by:
generating payment card data representing a payment card linked to a payment account of a first individual, the payment card linked to a card association entity and a corresponding issuing financial institution;
processing the payment card data to generate authorization request data, the authorization request data requesting authorization for a second individual to make a payment using the payment account of the first individual; and
transmitting the authorization request data to the card association entity and receiving, in response, payment authorization data, the payment authorization data indicating whether the payment is authorized, wherein if the payment is authorized, the transaction can be performed at a payment device when a payment account identifier and a corresponding security code, both of which are included in the payment authorization data, are presented to the payment device.

17. The user device of claim 16, wherein the user device is configured to make a payment from a shared payment card by implementing the process of claim 15.

18. A data processor implemented process for authorizing a shared card payment, the process being executed by the at least one processor, and comprising:
receiving authorization request data requesting authorization for a second individual to make a payment with a payment card linked to a payment account of a first individual, the payment card issued by an issuing financial institution;
processing the received authorization request data to generate card owner notification data representing a notification of the second individual's request for authorization to make the payment;
transmitting the card owner notification data to the first individual, the transmission performed over a communications network;
receiving card owner authorization data representing the approval, by the first individual, of the payment request;
processing the received card owner authorization data to generate payment authorization that includes an indication that the payment is authorized; and
transmitting the payment authorization data to the second individual, such that the payment can be performed at a payment device when a payment account identifier and a corresponding security code, both of which are included in the payment authorization data, are presented to the payment device.

19. The shared card payment authorization process of claim 18, wherein the payment card is registered as a shared payment card in respect of the second individual, and wherein the registration of a candidate payment card as a shared payment card in respect of the second individual includes:
receiving, from a user device, registration request data representing a request to register the candidate payment card;
processing the registration request data to generate registration confirmation data that indicates, when the registration of the candidate payment card as a shared payment card is approved, that the candidate payment card is a registered shared payment card; and
transmitting the generated registration confirmation data to the user device, wherein the registration request data includes, at least, an indication of the card number, the issuing financial institution, and the card ICA value, of the candidate payment card, and wherein the processing of the registration request data includes:
processing at least one of i) the card number, ii) the indication of the issuing financial institution, and iii) the card ICA value to generate a registration request notification indicating the intention of the second individual to register the candidate payment card as a shared payment card;
transmitting the registration request notification to the issuing financial institution;
receiving a registration request response from the issuing financial institution indicating the approval or rejection of the registration of the candidate payment card with the second individual; and
generating, if the registration of the candidate payment card is approved, a registration key, the registration key uniquely representing the registration of the candidate payment card with the second individual, wherein the registration request response is generated by the issuing financial institution based on whether the first individual approves or rejects the registration of the candidate payment card with the second individual.

20. (canceled)

21. (canceled)

22. (canceled)

23. (canceled)

24. The shared card payment process of claim 18, wherein the authorization request data includes the payment card data, transaction information data indicating details of the payment transaction to be performed by the second individual, and identification data identifying the second individual, wherein the transaction information data includes a value of the payment and a currency of the payment, and wherein the data identifying the second individual includes one or more of the name, address, telephone number, email, and username of the second individual.

25. (canceled)

26. (canceled)

27. The shared card payment authorization process of claim 18, wherein the payment identifier is a QR code generated by the card association entity and containing the information of the payment account of the first individual, wherein the information of the payment account of the first individual includes one or more of i) the name of the first individual, ii) a Personal Account Number (PAN) of the payment account, iii) an expiration date of the payment card, and iv) a verification value of the payment card wherein the security code is one of i) the PIN code of the payment card, and ii) a one-time PIN (OTP) code, wherein the OTP is generated dynamically using an encryption algorithm with an associated OTP generation key to encrypt the PAN value in combination with a seed value, and wherein the payment account identifier and the security code operate as a token pair encapsulating the PAN of the payment account and the PIN of the payment card during the exchanges of data between the card association entity and the second individual in relation to the payment.

28. The shared card payment authorisation process of claim 27, wherein the information of the payment account of the first individual includes one or more of: the name of the first individual: a Personal Account Number (PAN) of the payment account; an expiration dale of the payment card; and a verification value of the payment card.

29. The shared card payment authorisation process of any one of claims 18 to 28, wherein the security code is one of: the PIN code of the payment card, and a one-time PIN (OTP) code.

30. The shared card payment authorisation process of claim 29, wherein the OTP is generated dynamically using an encryption algorithm with an associated OTP generation key to encrypt the PAN value in combination with a seed value.

31. The shared card payment authorisation process of any one of claims 29 to 30, wherein the payment account identifier and the security code operate as a token pair encapsulating the PAN of the payment account and the PIN of the payment card during the exchanges of data betw een the card association entity and the second individual in relation to the payment.

32. The shared card payment authorization process of claim 18, wherein the payment account identifier and security code expire after a predetermined period of time, such that, once the payment account identifier and security code have expired, the payment transaction cannot be performed at the payment device when the payment account identifier and the security code are presented to the payment device.

33. A data processor implemented process for conducting a payment transaction made with a shared card, the process being executed by at least one processor, and comprising:
receiving from a payment device:
i) transaction information data representing a payment transaction requested by an individual in respect of the payment account; and
ii) payment authorization data, including an indication that the payment transaction is authorized;
processing the payment authorization data and the transaction information data to produce validity data indicating whether the payment transaction specified by the transaction information data can be validly performed, the validity data based on an indication of prior authorization by the card owner for the individual to perform the payment transaction with the payment account;
generating, if the payment transaction is valid, financial transaction data representing a standard financial transaction message for conducting the payment transaction;
transmitting the standard financial transaction message to the issuing financial institution for processing, and receiving corresponding response data indicating the success or failure of the payment transaction;
generating, if the response data indicates a success of the payment transaction, shared payment transaction record data indicating that the payment transaction has been performed with the payment card; and
transmitting the response data to the payment device to allow completion of the payment transaction.

34. The shared card payment transaction process of claim 33, wherein the payment authorization data includes a payment account identifier and a corresponding security code, and wherein the indication of prior authorization by the card owner is provided by the payment authorization data generated according to claim 18.

35. (canceled)

36. A card association entity system, including at least one computing device configured to authorize a shared card payment by:
receiving authorization request data requesting authorization for a second individual to make a payment with a payment card linked to a payment account of a first individual, the payment card issued by an issuing financial institution;
processing the received authorization request data to generate card owner notification data representing a notification of the second individual's request for authorization to make the payment;
transmitting the card owner notification data to the first individual, the transmission performed over a communications network;
receiving card owner authorization data representing the approval, by the first individual, of the payment request;
processing the received card owner authorization data to generate payment authorization that includes an indication that the payment is authorized; and
transmitting the payment authorization data to the second individual, such that the payment can be performed at a payment device when a payment account identifier and a corresponding security code, both of which are included in the payment authorization data, are presented to the payment device.

37. The card association entity system of claim 36, wherein the card association entity system is configured to authorize a shared card payment by implementing the process of claim 19.

38. A card association entity system, including at least one computing device configured to conduct a payment transaction made with a shared card by:
receiving from a payment device:
i) transaction information data representing a payment transaction requested by an individual in respect of the payment account; and
ii) payment authorization data, including an indication that the payment transaction is authorized;
processing the payment authorization data and the transaction information data to produce validity data indicating whether the payment transaction specified by the transaction information data can be validly performed, the validity data based on an indication of prior authorization by the card owner for the individual to perform the payment transaction with the payment account;
generating, if the payment transaction is valid, financial transaction data representing a standard financial transaction message for conducting the payment transaction;
transmitting the standard financial transaction message to the issuing financial institution for processing, and receiving corresponding response data indicating the success or failure of the payment transaction;
generating, if the response data indicates a success of the payment transaction, shared payment transaction record data indicating that the payment transaction has been performed with the payment card; and
transmitting the response data to the payment device, to allow completion of the payment transaction.

39. The card association entity system of claim 38, wherein the card association entity system is configured to conduct a payment transaction made with a shared card by implementing the process of claim 34.

40. (canceled)

41. (canceled)

42. (canceled)

43. (canceled)

44. (canceled)

45. A payment system, including at least one computing device being configured to perform a shared card payment transaction by:
receiving from a computing device of a second individual:
i) transaction information data representing a payment transaction requested in respect of the payment account; and
ii) payment authorization data, including an indication that the payment transaction is authorized;
processing the payment authorization data to generate authentication data indicating whether the second individual is permitted to transact the payment account;
transmitting, if the second individual is permitted to transact the payment account, the payment authorization data and the transaction information data to a card association entity linked to the payment account, the card association entity configured to provide response data by processing the payment authorization data and the transaction information data according to claim 18; and
processing the response data received from the card association entity to complete the transaction.

46. (canceled)
